(19) United States
(12) Patent Application Publication
(10) Pub. No.: US 2023/0182217 A1
(43) Pub. Date: Jun. 15, 2023

(54) COMBINATION SYSTEM OF FIXED ARBOR HOLE SAWS AND QUICK-CHANGE MANDREL

(71) Applicant: Kailash C Vasudeva, Waterloo (CA)

(72) Inventor: Kailash C Vasudeva, Waterloo (CA)

(21) Appl. No.: 18/081,583

(22) Filed: Dec. 14, 2022

Related U.S. Application Data
(60) Provisional application No. 63/289,157, filed on Dec. 14, 2021.

(51) Int. Cl. B23B 51/04

(52) U.S. Cl. CPC B23B 51/0426

(57) ABSTRACT

A combination system of fixed arbor hole saws and quick-change mandrel that enables a user to drill multiple of same sized or different sized holes in desired substrate in a quick and hassle-free manner. A drill bit held and retained in the quick-change mandrel serves as a common pilot for all different fixed arbor hole saws. The combo system requires a single common quick lock mandrel that positively locks a hole saw on insertion. The securely locked hole saw can be released with easy pull on a collar in the mandrel. Also, the cut-out slug of any substrate is very easy to remove once the hole saw is released from the mandrel.

### CROSS REFERENCE TO RELATED APPLICATION

This application claims priority to U.S. Provisional Pat. Application No. 63/289,157, filed on Dec. 14, 2021, the entire disclosure of which is hereby incorporated by reference.

### TECHNICAL FIELD

This application related to an integral part of Power Tool Accessory (PTA) industry.

### BACKGROUND OF THE INVENTION

In general, Hole Saws are an integral part of Power Tool Accessory (PTA) industry. Fixed Arbor hole saws are a category of hole saws that come with pre attached hex shank arbors. The most popular hex size for these fixed arbors is ¹1₄″, ⅜″ and 7/16″. Hence these fixed arbor hole saws can be directly held into a three-jaw chuck of a powered hand drill or a drill press. These fixed arbor hole saws invariably have provision of mounting a pilot drill bit retained by a set screw in the arbor portion. Also, for a set of fixed arbor hole saws, one needs to have either a pilot drill bit mounted in every hole saw or the pilot bit will have to be removed from one hole saw to be used in another for drilling holes of different sizes.

### SUMMARY

In this invention, a combine of the fixed arbor hole saws with a Quick Connect Mandrel that can accept and hold a pilot drill bit is provided. As a preferred embodiment of this invention a fixed arbor size of 7/16″ hex is being considered. The hex arbor of the hole saw has a clear hole for the pilot bit to pass through. The quick-connect mandrel with extending pilot drill bit is held in a drill chuck. The required size of hole saw having a hex arbor with clear hole for pilot bit is inserted over the pilot bit all the way until the hole saw is locked into the quick connect mandrel. The hole saw can be unlocked and removed by activating a spring biased sleeve/collar. The locking mechanism can be surface locking on hex arbor or locking into a grove or indent on the hex arbor.

This innovative system helps in reducing hole saw change time. Also, the pilot bit is fixed in the quick connect mandrel and is common for all fixed arbor hole saws, hence no need of pilot bit changes or no need of multiple pilot bits, thus saving time and money It can also help for removing the slug.

### BRIEF DESCRIPTION OF THE DRAWING

The following detailed description can be best understood when read in conjunction with the drawing enclosed herewith, wherein:

FIGS. 1-3 show prior art of fixed arbor hole saws as used presently.

FIG. 4 Shows a quick-change mandrel 20 with pilot bit is held in power drill

FIG. 5 shows a quick-change mandrel 30 having a pilot bit 31 retained/locked by set screw 32 and spring biased sleeve/collar

FIG. 6 shows components of a fixed arbor hole saw;

FIG. 7a shows a conventional fixed arbor Hole saw 50 chucked into a power drill 52;

FIG. 7b shows efforts being made to remove the slug to drill next hole.

FIG. 7c shows the struggle still on for removing the slug.

FIG. 8a shows the novel quick-change mandrel 62 chucked into power drill 63

FIG. 8b shows the released fixed arbor hole saw moved out of quick-change mandrel resulting in stripping off the slug from the pilot bit;

FIG. 8c shows slug fully dislodged from hole saw

FIGS. 8d and 8e shows a pilot bit have larger cutting head with a stepped back or tapering body

FIG. 9a shows hole saw 70 cutting into wood block 71 having a compression spring

FIG. 9b shows the cut out wooden slug inside the hole saw 70 and stuck onto pilot bit and the spring 74 in a compressed state.

FIG. 9c shows the hole saw released from quick change mandrel, the slug stripped off pilot bit and kicked out of the hole saw as the compression spring extends to its free length.

FIG. 10a shows hole saw 80 having kick pins 85 retained in back plate of hole saw

FIG. 10b shows cut slug fully sitting into the hole saw 80 pushing back the kick pins 85.

FIG. 10c shows the fixed arbor hole saw out of quick-change mandrel & slug kicked out for easy access.

### DETAILED DESCRIPTION

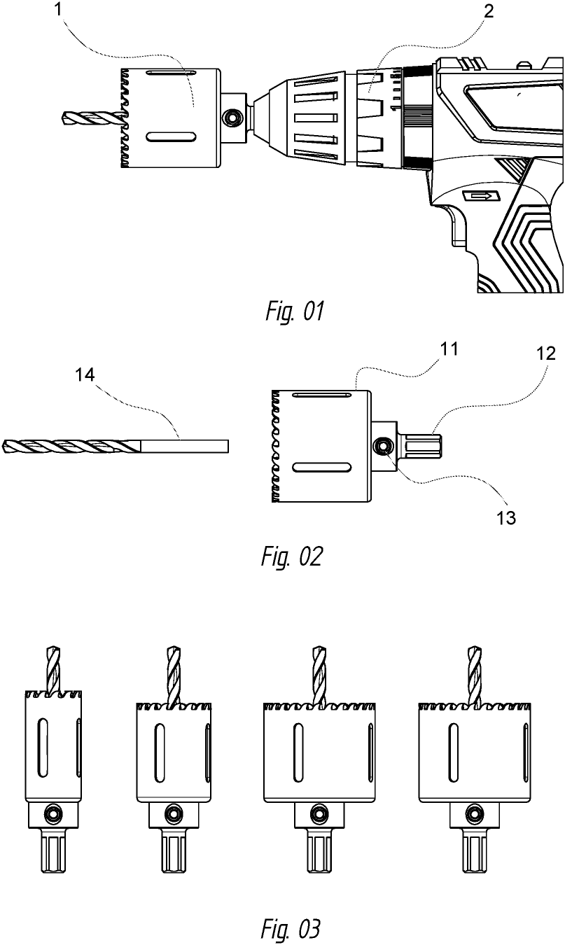

FIGS. 1, 2 & 3 show prior art of fixed arbor hole saws as used presently. A fixed arbor hole saw 1 with pilot bit is used with power drill 2 to drill holes in suitable substrate.

FIG. 2 shows pilot bit 14 removed from hole saw assembly. The assembly comprising of a hole saw 11, fixed arbor 12, and set screw 13 for holding/releasing the pilot bit.

FIG. 3 shows different sizes of fixed arbor hole saws with pilot bits for ready use with a power drill. Alternatively, a common pilot drill bit could be used transferring the same from one hole saw to another that calls for a time-consuming process.

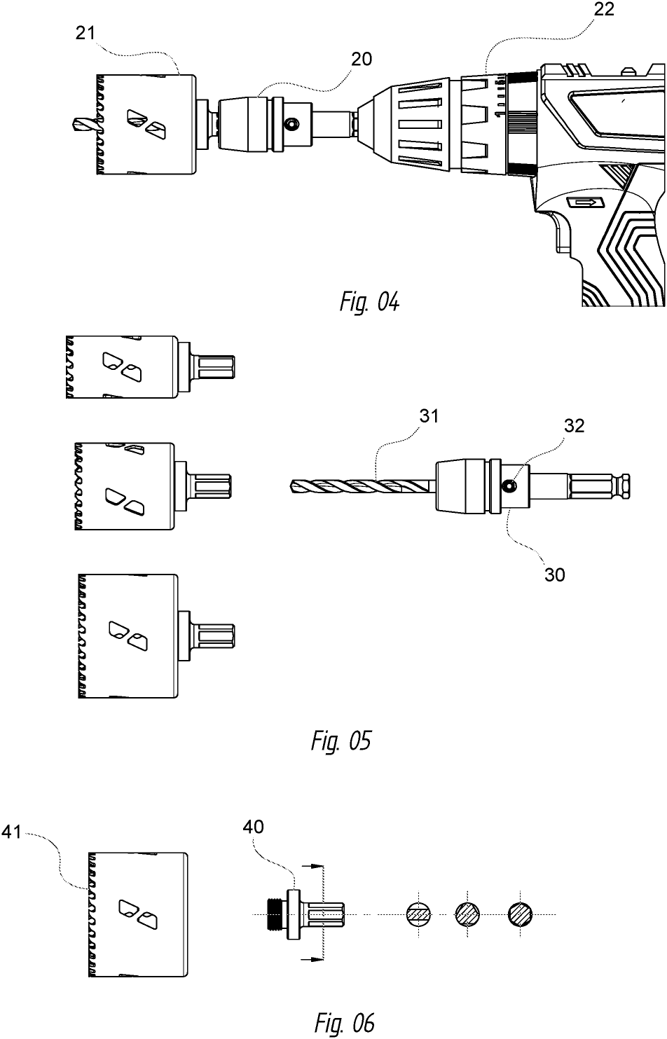

FIGS. 4 & 5 show images depicting salient features/functions of this novel invention. In FIG. 4 the quick-change mandrel 20 with pilot bit is held in power drill 22. A fixed arbor hole saw 21 with a clear hole in hex arbor goes over the pilot bit and is removably locked in the quick-change mandrel. In FIG. 5 shows a quick-change mandrel 30 having a pilot bit 31 retained/locked by set screw 32 and spring biased sleeve/collar 33 that helps locking and release of fixed arbor hole saw. Also shown in FIG. 5 different sized fixed arbor hole saws that can be quickly locked into and released from the quick-change mandrel 30.

FIG. 6 shows components of a fixed arbor hole saw. Hex shank arbor 40 and the hole saw 41 are the two primary components. The arbor 40 could be fixed to the hole saw 41 by threading or by welding.

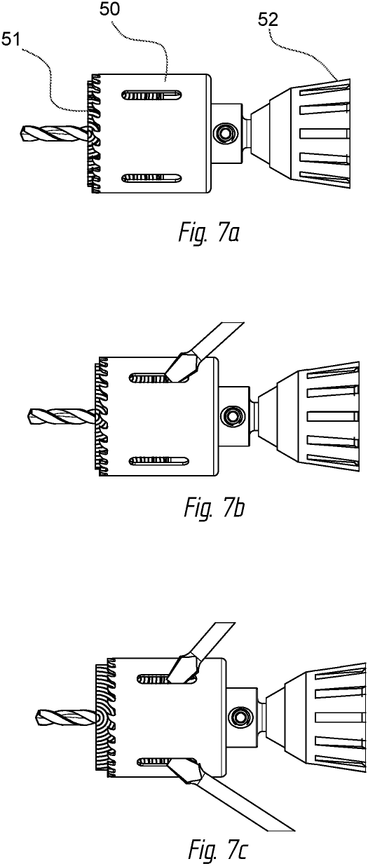

FIG. 7a shows a conventional fixed arbor Hole saw 50 chucked into a power drill 52. A slug 51 of the substrate drilled is stuck/sandwiched between pilot bit and hole saw. FIG. 7b shows efforts being made to remove the slug to drill next hole. FIG. 7c shows the struggle still on for removing the slug. This can be very frustrating and time consuming as chips/cuttings during drilling get jammed in pilot drill flutes.

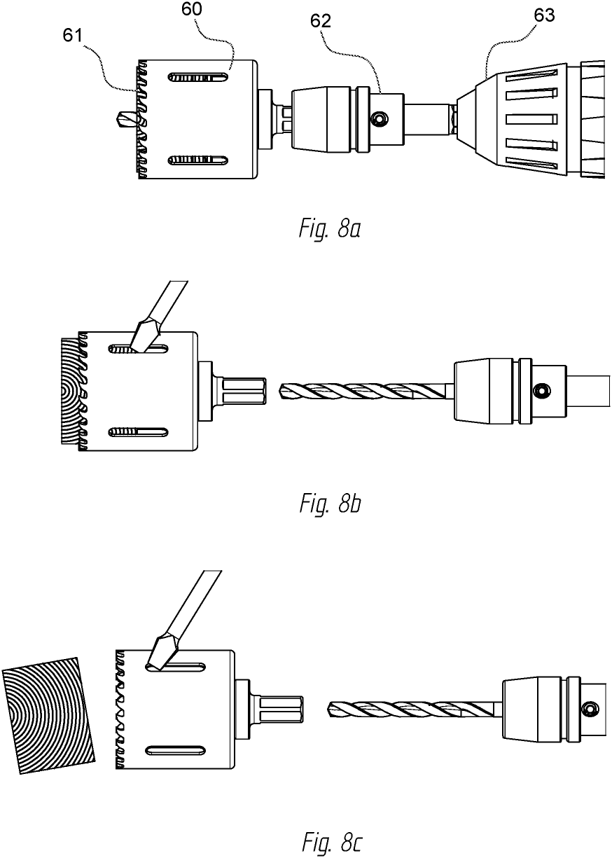

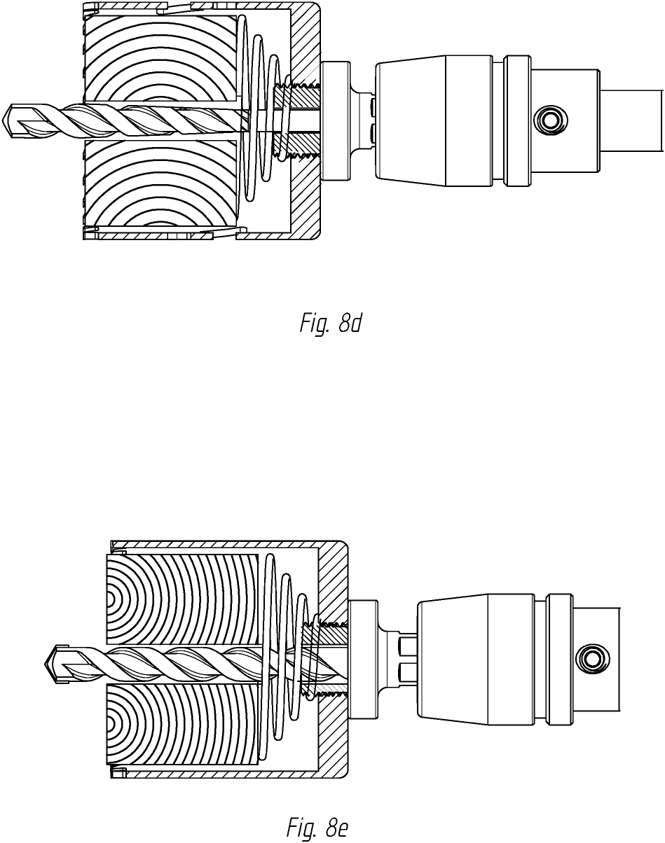

FIG. 8a shows the novel quick-change mandrel 62 chucked into power drill 63. A fixed arbor hole saw 60 is locked into quick-change mandrel 62. A slug 61 of the substrate drilled is inside the hole saw 60. The slug is primarily jammed stuck on the pilot bit and is comparatively loosely retained within the hole saw 60 due to hole saw tooth setting.

FIG. 8b shows the released fixed arbor hole saw moved out of quick-change mandrel resulting in stripping off the slug from the pilot bit. It is now very easy to push out the slug sitting loosely in hole saw.

FIG. 8c shows slug fully dislodged from hole saw. The fixed arbor hole saw is ready to be quick locked into quick-change mandrel for the next hole drilling.

The above sequence shows how quick and easy it is to drill holes with this invention system. This is the preferred embodiment of our invention.

As a second embodiment of this invention, the pilot bit could have larger cutting head with a stepped back or tapering body (FIGS. 8d and 8e) to further reduce sticking of slug on the bit.

Yet as per another embodiment a compression spring or a spring-loaded disk attached to the base plate of hole saw could be incorporated to assist pushing out cut slug from hole saw once the slug is freed up from the pilot bit.

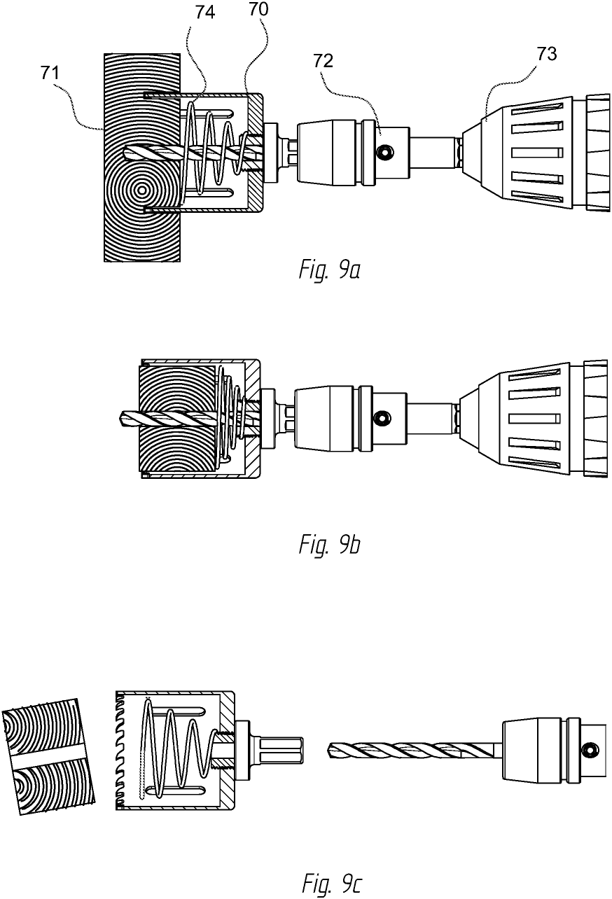

FIG. 9a shows hole saw 70 cutting into wood block 71 having a compression spring 74 attached to the base plate of hole saw. Quick change mandrel 72 locks onto hex arbor of hole saw and is chucked into a power drill 73.

FIG. 9b shows the cut out wooden slug inside the hole saw 70 and stuck onto pilot bit and the spring 74 in a compressed state.

FIG. 9c shows the hole saw released from quick change mandrel, the slug stripped off pilot bit and kicked out of the hole saw as the compression spring extends to its free length.

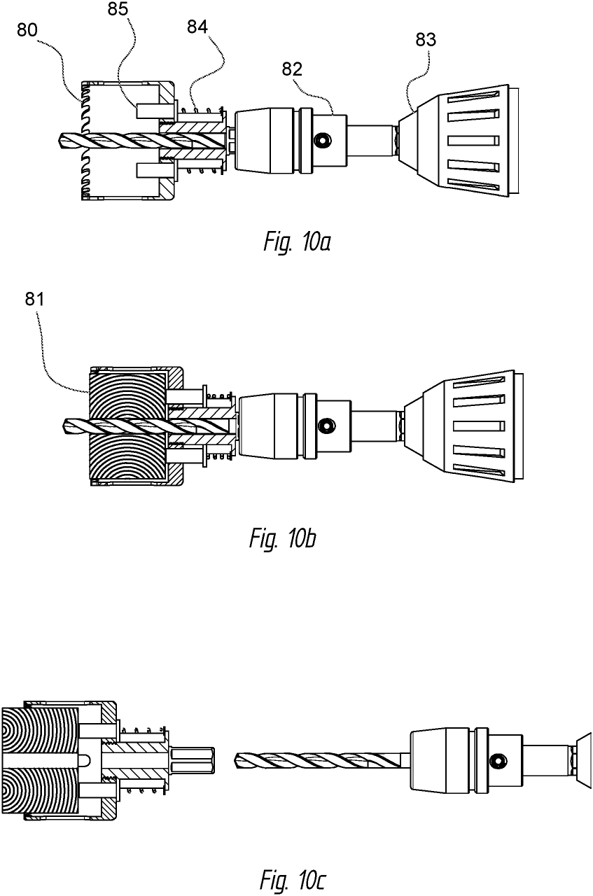

FIGS. 10a to 10c show another embodiment of this invention. FIG. 10a shows hole saw 80 having kick pins 85 retained in back plate of hole saw and biased by a compression spring 84 around fixed arbor head. The fixed arbor hole saw locked into quick change mandrel 82 that is further chucked into power tool 83.

FIG. 10b shows cut slug fully sitting into the hole saw 80 pushing back the kick pins 85.

FIG. 10c shows the fixed arbor hole saw out of quick-change mandrel & slug kicked out for easy access.

1. A combination of hole saws having fixed arbor and a quick locking mandrel system for quick interchangeability of hole saw, the mandrel system includes a drill bill and the hole saw include a hole to go over the bit.

2. The combination of hole saws having fixed arbor and a quick locking mandrel system as in claim 1, wherein the Cross-section shape of arbor is hex.

3. The combination of hole saws having fixed arbors and a quick locking mandrel system claim 1, wherein the Cross-section shape of arbor is a round with two flats.

4. The combination of claim 1, wherein the Cross-section shape of arbor is a round with three flats.

5. The combination of hole saws having fixed arbors and a quick locking mandrel system as in claim 1, wherein further having an easy slug removal function.

6. The combination of hole saws having fixed arbors and a quick locking mandrel system as in claim 1, further having a single common mandrel for different sizes of hole saws.

7. The combination of hole saws having fixed arbors and a quick locking mandrel system as in claim 1, further having a single common pilot bit fitted in the mandrel for all hole saws.

8. The combination of hole saws having fixed arbors and a quick locking mandrel system as in claim 1, having the pilot bit with reducing diameter backwards through tapering down or stepping down.

9. The combination of hole saws having fixed arbors and a quick locking mandrel system as in claim 1, further having an easy slug removal function assisted by a compression spring fitted within the hole saw.

10. The combination of hole saw having fixed arbors and a quick locking mandrel system as in claim 1 4 further having an easy slug removal function assisted by kicker pin mechanism attached to the hole saw.
